(19) United States
(12) Patent Application Publication
(10) Pub. No.: US 2026/0027846 A1
(43) Pub. Date: Jan. 29, 2026

(54) APPARATUS COUPLING STRUCTURE, IMAGE FORMING SYSTEM AND APPARATUS COUPLING METHOD

(71) Applicant: KYOCERA Document Solutions Inc., Osaka (JP)

(72) Inventor: Kuniaki ARAISHI, Osaka (JP)

(73) Assignee: KYOCERA Document Solutions Inc., Osaka (JP)

(21) Appl. No.: 19/271,159

(22) Filed: Jul. 16, 2025

(30) Foreign Application Priority Data
Jul. 26, 2024 (JP) 2024-120836

(51) Int. Cl. B41J 29/02; G03G 21/16

(52) U.S. Cl. CPC B41J 29/02; G03G 21/1619

(57) ABSTRACT

An apparatus coupling structure includes a plurality of coupled apparatus and an adjustment plate. The coupled apparatuses include a body frame formed with a fastening groove having a T-shaped cross section, and is installed on an installation surface. The adjustment plate is formed in a rectangular parallelepiped shape having a thickness capable of fitting into the fastening groove, long and short sides having a predetermined dimension. The dimension of the long side of the adjustment plate corresponds to a bottom-up dimension from the installation surface to a bottom of the body frame. The dimension of the short side of the adjustment plate corresponds to an inter-apparatus dimension of the adjacent body frames. The adjustment plate is fitted into the fastening grooves in a posture in which the short side is disposed between the adjacent coupled apparatuses, and the adjacent coupled apparatuses are coupled with the adjustment plate.

### INCORPORATION BY REFERENCE

This application is based on and claims the benefit of priority from Japanese patent application No. 2024-120836 filed on Jul. 26, 2024, which is incorporated by reference in its entirety.

### TECHNICAL FIELD

The present disclosure relates to an apparatus coupling structure which couples a plurality of apparatuses, an image forming system and an apparatus coupling method.

### BACKGROUND

An apparatus coupling member for coupling an image forming apparatus and a plurality of paper post-processing apparatuses is known. In order to successively couple the plurality of paper post-processing apparatuses in order, the apparatus coupling member has a shape in which the positions of the reference pins and the screw holes are different for each apparatus.

However, the above-described technique has a problem that an apparatus coupling member having a different shape must be prepared for each paper post-processing device, and the manufacturing cost increases.

### SUMMARY

An apparatus coupling structure according to the present disclosure includes a plurality of coupled apparatus and an adjustment plate. The plurality of coupled apparatuses include a body frame constructed of a frame material formed with a fastening groove having a T-shaped cross section, and is installed on an installation surface. The adjustment plate couples the adjacent coupled apparatuses. The adjustment plate is formed in a rectangular parallelepiped shape having a thickness capable of fitting into the fastening groove, long and short sides having a predetermined dimension. The dimension of the long side of the adjustment plate corresponds to a bottom-up dimension from the installation surface to a bottom of the body frame. The dimension of the short side of the adjustment plate corresponds to an inter-apparatus dimension of the adjacent body frames. The adjustment plate is fitted into the fastening grooves in a posture in which the short side is disposed between the adjacent coupled apparatuses, and the adjacent coupled apparatuses are coupled with the adjustment plate.

An image forming system according to the present disclosure includes the apparatus coupling structure. The coupled apparatuses include an image forming apparatus for forming an image on a paper.

An apparatus coupling method according to the present disclosure couples a plurality of coupled apparatuses having a body frame constructed of a frame material having a fastening groove having a T-shaped cross section using an adjustment plate formed in a rectangular parallelepiped shape having a thickness capable of being fitted to the fastening groove, long and short sides having a predetermined length. The apparatus coupling method includes a height adjusting step, a horizontal adjusting step, and a coupling adjusting step. In the height adjusting step, a short side surface of the adjustment plate is brought into contact with the installation surface, the adjustment plate is stood upright on the installation surface, and the bottom-up dimension from the installation surface to the bottom of the body frame is adjusted to the dimension of the long side of the adjustment plate. In the horizontal adjusting step, the adjustment plate is fitted to the fastening groove to level the body frame while referring to a level placed on the adjustment plate. In the coupling adjusting step, the adjustment plate is held in a posture in which the short side is disposed between the adjacent coupled apparatuses, the adjustment plate is fitted into the fastening grooves to couple the adjacent coupled apparatuses with the adjustment plate.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic (front view) showing an image forming system according to one embodiment of the present disclosure.

FIG. 2 is a perspective view showing a part of an apparatus coupling structure according to the embodiment of the present disclosure.

FIG. 3 is a perspective view explaining a housing state of an adjustment plate of the apparatus coupling structure according to the embodiment of the present disclosure.

FIG. 4 is a flowchart showing a device coupling method according to the embodiment of the present disclosure.

FIG. 5 is a front view explaining for a height adjusting step of the device coupling method according to the embodiment of the present disclosure.

FIG. 6 is a front view explaining for a horizontal adjusting step of the device coupling method according to the embodiment of the present disclosure.

FIG. 7 is a front view explaining for a coupling adjusting step of the device coupling method according to the embodiment of the present disclosure.

### DETAILED DESCRIPTION

Hereinafter, with reference to the accompanying drawings, embodiments of the present disclosure will be described. Fr, Rr, L, R, U and D shown in the drawings indicate the front, rear, left, right, upper and down. The front-and-rear direction, the left-and-right direction and the upper-and-down direction are orthogonal to each other. Although orientation and position terms are used herein, these terms are used for convenience of description and do not limit the technical scope of the present disclosure. The terms “upstream”, “downstream” and the like refer to the concepts “upstream”, “downstream” and the like in the conveyance direction of the paper (medium). In each of the figures, the dimensions and angles of the members are not accurate and are schematized for the sake of illustration.

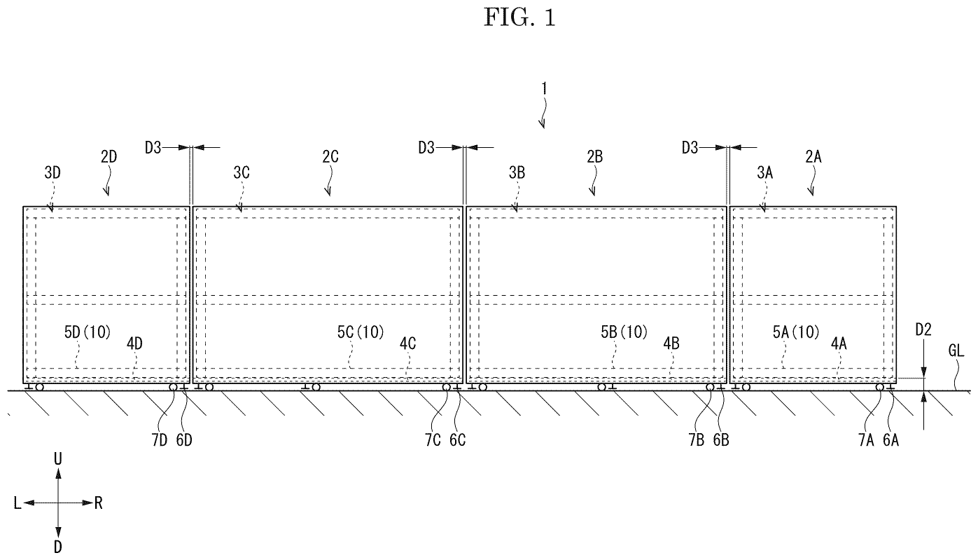

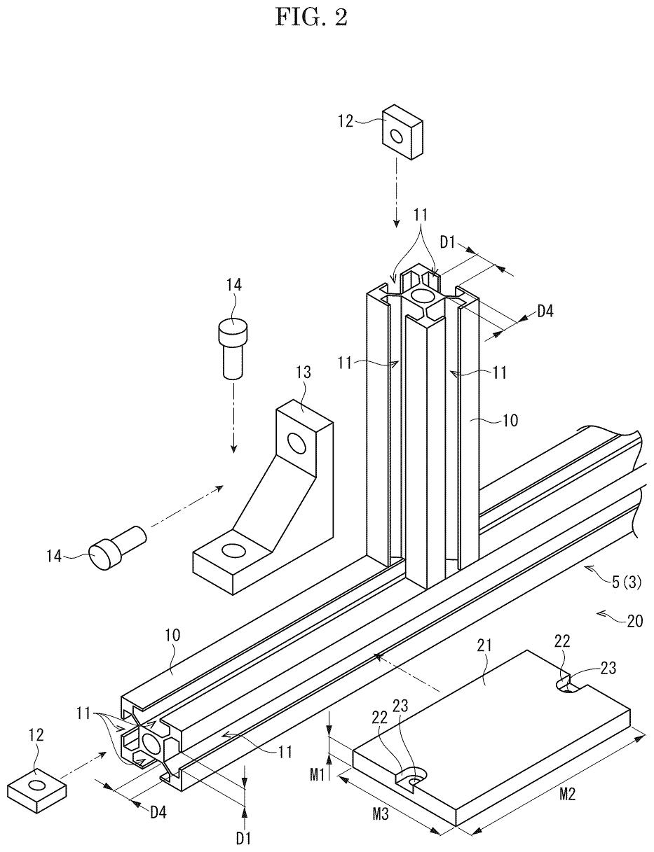

With reference to FIG. 1 and FIG. 2, an image forming system 1 according to the embodiment will be described. FIG. 1 is a schematic view (side view) showing the image forming system 1. FIG. 2 is a perspective view showing a part of an apparatus coupling structure 20 provided in the image forming system 1.

As shown in FIG. 1, the image forming system 1 includes a paper feeding apparatus 2A, an image forming apparatus 2B, a drying apparatus 2C, and a discharging apparatus 2D. The paper feeding apparatus 2A, the image forming apparatus 2B, the drying apparatus 2C, and the discharging apparatus 2D are arranged in a line from the upstream side to the downstream side in this order, and are installed on an installation surface GL (floor surface).

The image forming apparatus 2B is an inkjet printer which forms an image on a paper by ejecting ink from a recording head. The paper feeding apparatus 2A is coupled adjacent to the upstream side of the image forming apparatus 2B. The paper feeding apparatus 2A includes a paper feeding cassette which stores various kinds of papers, and a conveyance roller which feeds the papers stored in the paper feeding cassette and conveys them toward the image forming apparatus 2B. The paper is conveyed along a conveyance path formed from the paper feeding apparatus 2A, the image forming apparatus 2B, the drying apparatus 2C, and the discharging apparatus 2D. The drying apparatus 2C is coupled adjacent to the downstream side of the image forming apparatus 2B. The drying apparatus 2C has a heater or the like for drying an image (ink) on the paper fed from the image forming apparatus 2B. The discharging apparatus 2D is coupled adjacent to the downstream side of the drying apparatus 2C. The discharging apparatus 2D discharges the paper fed from the drying apparatus 2C onto a discharge tray.

The paper feeding apparatus 2A, the image forming apparatus 2B, the drying apparatus 2C, and the discharging apparatus 2D each have body frames 3A, 3B, 3C, and 3D constructed of frame materials 10 (see FIG. 1). In the present specification, in order to simplify the description, when the paper feeding apparatus 2A, the image forming apparatus 2B, the drying apparatus 2C and the discharging apparatus 2D are collectively described, they are referred to as “coupled apparatus 2”, and shown by only Arabic numerals as the reference numerals. Also, the components included in the apparatuses 2A to 2D are shown by Arabic numerals and alphabets as the reference numerals when they are described separately, and only by Arabic numerals as the reference numerals when they are described collectively. Further, in order to simplify the description, the description will be mainly focused on the image forming apparatus 2B and the drying apparatus 2C.

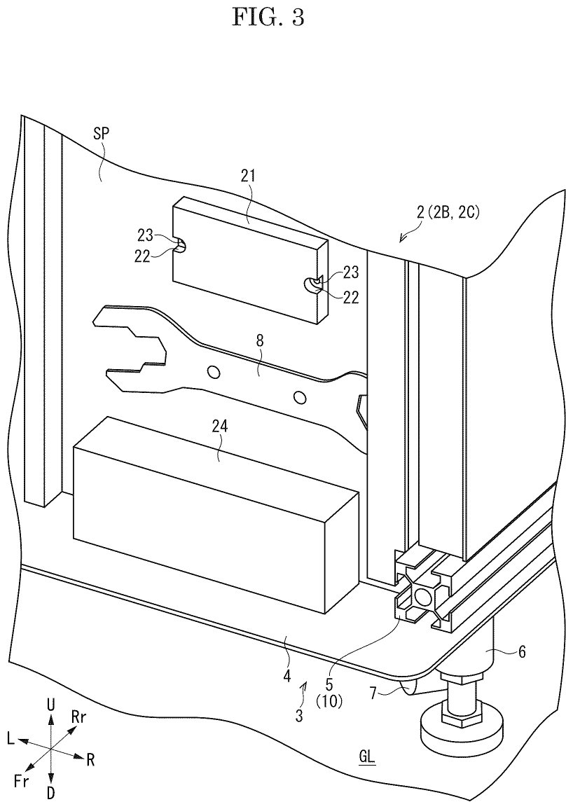

The body frame 3 includes bottom plates 4 (4A to 4D) constituting a bottom surface and base frames 5 (5A to 5D) fixed on the bottom plate 4 (see also FIG. 3, which will be described later). The bottom plate 4 is, for example, a flat plate made of metal such as SECC (Steel Electrolytic Cold Commercial). The base frame 5 is constituted of frame materials 10 assembled in a ladder shape when viewed from a plane.

On the lower surface of the bottom plate 4, a plurality of (for example, four to six) level bolts 6 and a plurality of (for example, four to six) casters 7 are provided at positions corresponding to the base frames 5 (see also FIG. 3, which will be described later). For example, in the image forming apparatus 2B and the drying apparatus 2C, the six level bolts 6 are provided at four corners of the bottom plate 4 and near the center in the left-and-right direction on both sides in the front-and-rear direction. The level bolt 6 is provided with a leg portion in a shape of a circular plate at the lower end of an adjustment bolt, and adjusts the height (bottom-up dimension D2) of the body frame 3 by abutting the leg portion on the installation surface GL. More specifically, the body frame 3 is lifted and lowered by rotating the adjustment bolt in the forward and reverse direction around the axis using a tool 8 such as a spanner (see FIG. 3, which will be described later) to adjust the height of the body frame 3. The caster 7 is provided near the level bolt 6, and includes a wheel pivotably and rotatably held at the lower end of the adjustment bolt via a bracket. The caster 7 is provided so as to lift and lower the body frame 3 by rotating the adjustment bolt around the axis in both the forward and reverse directions using the tool 8 and to move the image forming apparatus 2B and the drying apparatus 2c by rolling the wheels on the installation surface GL. The number and position of the level bolts 6 and the casters 7 are not limited to the above, and may be appropriately changed.

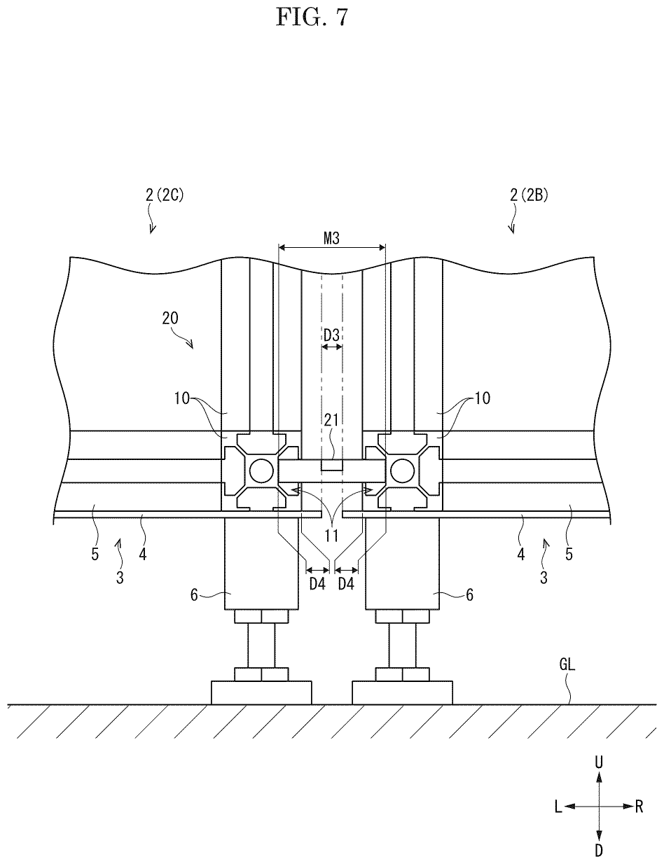

The frame material 10 is, for example, a square material made of aluminum alloy. As shown in FIG. 2, fastening grooves 11 having a generally T-shaped cross section are formed on four surfaces of the frame material 10 along the longitudinal direction. For example, when two frame materials 10 are crossed and coupled, nut members 12 are fitted into the fastening grooves 11, an angle piece 13 is disposed at a corner formed by crossing the two frame materials 10, and bolt members 14 penetrating the angle piece 13 are screwed into the nut members 12. In this manner, the plurality of frame materials 10 are coupled in an intersecting state via the angle pieces 13 to constitute the body frame 3.

[Apparatus coupling structure] The paper feeding apparatus 2A, the image forming apparatus 2B, the drying apparatus 2C, and the discharging apparatus 2D are arranged in a line (see FIG. 1), and the adjacent coupled apparatuses 2 are coupled via an adjustment plate 21. The adjustment plate 21 constitutes the apparatus coupling structure 20 together with various coupled apparatuses 2. The apparatus coupling structure 20 will be described below with reference to FIG. 2 and FIG. 3. FIG. 3 is a perspective view explaining for a housing state of the adjustment plate 21 and the like. The bottom-up dimension D2, which is the height from the installation surface GL to the bottom (for example, the upper surface of the bottom plate 4) of the body frame 3, and the inter-apparatus dimension D3, which is the distance between the adjacent coupled apparatuses 2, are determined to predetermined values when the image forming system 1 is designed.

<Adjustment Plate> The adjustment plate 21 is made of material having high rigidity such as metal or rigid synthetic resin. As shown in FIG. 2, the adjustment plate 21 is formed in a rectangular parallelepiped shape (thick plate shape) having a thickness M1 that can be fitted into the fastening groove 11 of the frame material 10. That is, the thickness M1 of the adjustment plate 21 is slightly smaller than the groove width D1 of the fastening groove 11. The groove width D1 refers to the width of the opening of the fastening groove 11 having a T-shaped cross section. The dimension of the long side of the adjustment plate 21 (hereinafter, it is referred to as “long side dimension M2”) corresponds to the bottom-up dimension D2 (see FIG. 1) from the installation surface GL to the upper surface of the bottom plate 4. That is, the long side dimension M2 of the adjustment plate 21 is approximately equal to the bottom-up dimension D2, and indicates the height of the body frame 3 from the installation surface GL. The dimension of the short side of the adjustment plate 21 (hereinafter, it is referred to as “short side dimension M3”) corresponds to the inter-apparatus dimension D3 of the adjacent coupled apparatuses 2 (see FIG. 1). More specifically, the short side dimension M3 of the adjustment plate 21 is approximately equal to a dimension obtained by adding 2×the depth D4 of the fastening groove 11 and 2×the distance D5 from the outer surface of the apparatus to the frame material 10 to the inter-apparatus dimension D3 (see FIG. 1), (D3+D4×2+D5×2 (see also FIG. 7, which will be described later)), and indicates an interval between adjacent coupled apparatuses 2.

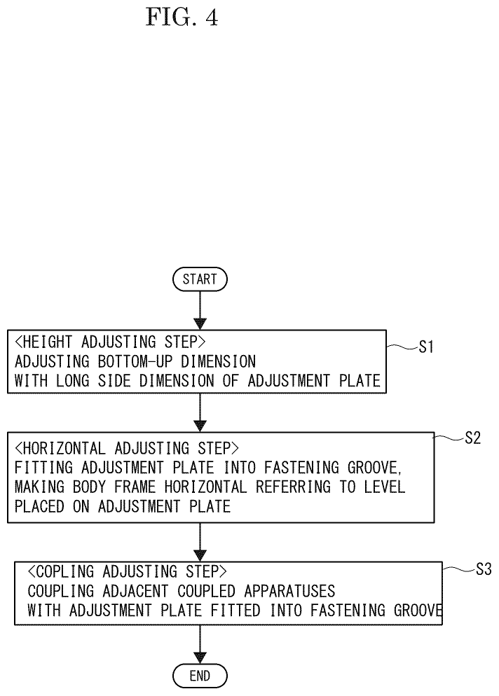

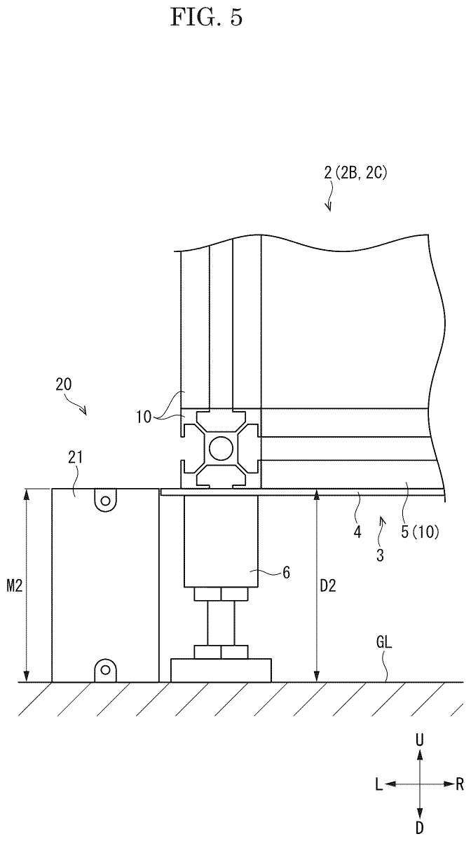

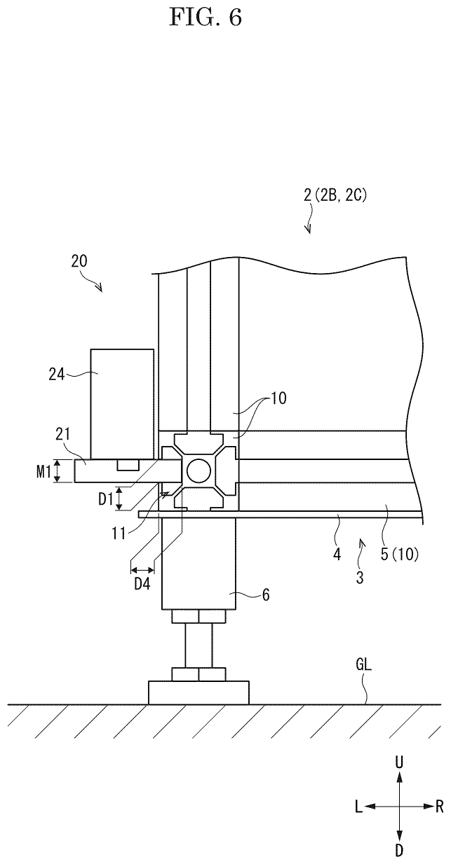

A pair of housing recesses 22 are provided at both end portions of the adjustment plate 21 in the long side direction. The housing recess 22 is substantially centered in the short side direction, and recessed from one plane surrounded by the pair of long sides and the pair of short sides to about half the thickness M1. A housing hole 23 penetrating in the thickness direction of the adjustment plate 21 is formed in the range of the housing recess 22. As shown in FIG. 3, the adjustment plate 21 when not in use is attached to a side plate SP constituting a part of the body frame 3 by a male screw (not shown) such as a screw or a bolt through the housing hole 23. Similarly, the tool 8 for rotating the level bolt 6 is attached to the side plate SP with a male screw. The side plate SP is provided inside the outer casing (not shown) and has a female screw hole (not shown) for screwing the male screw. That is, the adjustment plate 21 and the tool 8 when not in use are housed in the casing of the coupled apparatus 2.

[Apparatus Coupling Method] Next, with reference to FIG. 4 to FIG. 7, an operation of the apparatus coupling structure 20, in other words, an apparatus coupling method for coupling various coupled apparatuses 2, will be described. FIG. 4 is a flowchart showing the apparatus coupling method. FIG. 5 is a front view for explaining a height adjusting step S1 of the apparatus coupling method. FIG. 6 is a front view for explaining a horizontal adjusting step S2 of the apparatus coupling method. FIG. 7 is a front view for explaining a coupling adjusting step S3 of the apparatus coupling method. A case where the image forming apparatus 2B and the drying apparatus 2C are coupled will be described.

As shown in FIG. 4, the apparatus coupling method includes the height adjusting step S1, the horizontal adjusting step S2, and the coupling adjusting step S3. In the coupled apparatus 2 such as the image forming apparatus 2B in the shipping state, the caster 7 is set to have a dimension lower than the bottom-up dimension D2 of the coupled apparatus 2. The level bolt 6 is set to be positioned above the caster 7 and movable by the caster 7. In addition, the plurality of coupled apparatuses 2 are generally arranged at predetermined installation positions on the installation surface GL. The adjustment plate 21 and the tool 8 are removed from the body frame 3. In the apparatus coupling method, a level 24 possessed by a service man or the like is used.

<Height Adjusting Step of Image Forming Apparatus> As shown in FIG. 5, in the height adjusting step S1, for the image forming apparatus 2B which has been moved to the installation position using the casters 7, the operator brings one short side surface (one of both end surfaces in the long side direction) of the adjustment plate 21 into contact with the installation surface GL at a position along any of the four side surfaces of the front, rear, left and right side surfaces of the body frame 3, and stands the adjustment plate 21 upright on the installation surface GL. Then, the operator rotates the level bolt 6 by using the tool 8, and the bottom-up dimension D2 from the installation surface GL to the upper surface of the bottom plate 4 (the bottom of the body frame 3) is adjusted to the long side dimension M2 of the adjustment plate 21. That is, the operator rotates the level bolt 6 in the forward direction and reverse direction, lifts and lowers the body frame 3, and aligns the upper surface of the bottom plate 4 with the upper surface (the other short side surface) of the adjustment plate 21. At this time, the caster 7 is retracted upward from the installation surface GL, and the image forming apparatus 2B is supported by the installation surface GL by the level bolts 6.

The height adjusting step S1 of the image forming apparatus 2B is performed for all the level bolts 6 while the adjustment plates 21 are sequentially arranged at a total of four positions of the front, rear, left, and right sides of the body frame 3 (coupled apparatus 2). The height adjusting step S1 is performed for all the coupled apparatuses 2. Thereby, the height of the bottom plate 4 of the body frame 3 is adjusted to the bottom-up dimension D2. Since the installation surface GL has slight irregularities and is not a perfect horizontal plane, even if the height of the body frame 3 is adjusted to the bottom-up dimension D2, the body frame 3 often does not have a strictly horizontal posture.

<Horizontal Adjusting Step of Image Forming Apparatus> As shown in FIG. 6, in the horizontal adjusting step S2, the operator fits the adjustment plate 21 to the fastening groove 11 at a position along any of the four front, rear, left, and right side surfaces of the body frame 3, and places the level 24 on the adjustment plate 21 cantilevered by the fastening groove 11. The operator, while referring to the level 24 placed on the adjustment plate 21, rotates the level bolt 6 minutely by using the tool 8 to level the body frame 3. In the horizontal adjusting step S2, the body frame 3 is slightly lifted and lowered so as to absorb the irregularities of the installation surface GL, so that the bottom-up dimension D2 determined in the height adjusting step S1 does not change significantly. In FIG. 6, one side of the adjustment plate 21 in the short side direction is fitted into the fastening groove 11, but not limited thereto, one side of the adjustment plate 21 in the long side direction may be fitted into the fastening groove 11 (not shown).

In the horizontal adjusting step S2, as an example, first, the adjustment plate 21 is supported along the front side surface of the body frame 3, the level 24 is placed on the adjustment plate 21, and the level bolt 6 is rotated so as to adjust the height of the other side with reference to the height of one side in the left-and-right direction, making the adjustment plate horizontal. Next, the adjustment plate 21 is successively supported along each of the left and right side surfaces of the body frame 3, the level 24 is placed on the adjustment plate 21, and the level bolt 6 is rotated so as to adjust the height of the rear side with reference to the height of the front side, making the adjustment plate horizontal. Thus, the body frame 3 is adjusted to a horizontal posture. In this specification, the term “horizontal” does not mean that it is strictly horizontal, but means that a minute error (inclination) is allowed.

<Height Adjusting Step and Horizontal Adjusting Step of Drying Apparatus> The drying apparatus 2C is moved near the installation position of the image forming apparatus 2B. The height adjusting step S1 and the horizontal adjusting step S2 of the drying apparatus 2C are basically the same as the respective adjustments of the image forming apparatus 2B, but the level bolt 6 is not moved from its initial position, and the height of the caster 7 is adjusted, because it needs to be moved when it is coupled to the image forming apparatus 2B after the adjustment. That is, the height adjustment bolt of the caster 7 is rotated by using the tool 8, and the bottom-up dimension D2 from the installation surface GL to the upper surface of the bottom plate 4 (the bottom of the body frame 3) is adjusted to the long side dimension M2 of the adjustment plate 21. That is, the operator rotates the height adjustment bolt of the caster 7 in the forward and reverse directions to lift and lower the body frame 3 so that the upper surface of the bottom plate 4 is aligned with the upper surface (the other short side surface) of the adjustment plate 21.

Similarly, in the horizontal adjusting step S2, first, the adjustment plate 21 is supported along the front side surface of the body frame 3, the level 24 is placed on the adjustment plate 21, and the adjustment bolt of the caster 7 is rotated so as to adjust the height of the other side with reference to the height of one side in the left-and-right direction, making it horizontal. Next, the adjustment plate 21 is supported on each of the left and right side surfaces of the body frame 3, the level 24 is placed on the adjustment plate 21, and the adjustment bolt of the caster 7 is rotated so as to adjust the height of the rear side with reference to the height of the front side, making it horizontal.

<Coupling Adjusting Step> As shown in FIG. 7, in the coupling adjusting step S3, the operator holds the adjustment plate 21 in the posture in which the short side is disposed between the adjacent image forming apparatus 2B and the drying apparatus 2C, fits the adjustment plate 21 into the fastening grooves 11, and couples the adjacent image forming apparatus 2B and the drying apparatus 2C with the adjustment plate 21. Specifically, the operator inserts (fits) one short side (right side) of the adjustment plate 21 into the fastening groove 11 formed on the left side surface of the base frame 5B of the image forming apparatus 2B. Subsequently, the operator moves the drying apparatus 2C so as to be adjacent to the left side of the image forming apparatus 2B, and inserts (fits) the other short side (left side) of the adjustment plate 21 cantilevered by the fastening groove 11 of the base frame 5B, into the fastening groove 11 formed on the right side surface of the base frame 5C of the drying apparatus 2C.

After the drying apparatus 2C is coupled to the image forming apparatus 2B by the above-described operation, in order to regulate the movement of the drying apparatus 2C, the respective level bolts 6 of the drying apparatus 2C are rotated to press the leg portions against the installation surface GL. The force for pressing the leg portions against the installation surface GL is limited to a range in which the caster 7 does not float away from the installation surface GL.

As described above, the adjustment plate 21 is fitted into the fastening grooves 11 in the posture in which the short side is disposed between the adjacent coupled apparatuses 2, and the adjacent image forming apparatus 2B and the drying apparatus 2C are coupled with the adjustment plate 21. Similarly to the above, the image forming apparatus 2B and the paper feeding apparatus 2A are coupled with each other via the adjustment plate 21, and the drying apparatus 2C and the discharging apparatus 2D are coupled with each other with the adjustment plate 21. Thus, the various coupled apparatuses 2 are coupled to complete the image forming system 1 (see FIG. 1).

In the above-described apparatus coupling method, the adjacent coupled apparatuses 2 (body frame 3) are coupled with one adjustment plate 21, but the present disclosure is not limited thereto. For example, two or more adjustment plates 21 may be arranged at intervals in the front-and-rear direction, and may be fitted to the fastening grooves 11 in a posture where that the short side is disposed between the adjacent coupled apparatuses 2 (body frame 3) (not shown). That is, the adjacent coupled apparatuses 2 may be coupled via two or more adjustment plates 21.

In the apparatus coupling structure 20 according to the present embodiment described above, the thickness M1 of the adjustment plate 21 corresponds to the groove width D1 of the fastening groove 11 of the frame material 10, the long side dimension M2 of the adjustment plate 21 corresponds to the bottom-up dimension D2 of the body frame 3, and the short side dimension M3 of the adjustment plate 21 corresponds to the inter-apparatus dimension D3 of the adjacent coupled apparatuses 2. That is, the lengths of the three sides of the adjustment plate 21 each have a role. According to this configuration, the height (bottom-up dimension D2) of the body frame 3 can be adjusted in accordance with the dimension M2 of the adjustment plate 21 stood upright on the installation surface GL (see FIG. 5), and the body frame 3 can be adjusted in a horizontal posture by placing the level 24 on the adjustment plate 21 fitted in the fastening groove 11 (see FIG. 6). Further, by fitting both short side ends of the adjustment plate 21 to the fastening grooves 11 of the adjacent body frames 3, the adjacent coupled apparatuses 2 (body frames 3) can be installed at a predetermined interval (inter-apparatus dimension D3) (see FIG. 7). As a result, the bottom-up dimension D2, the horizontality, and the inter-apparatus dimension D3 of the body frame (various kinds of coupled apparatus 2) can be properly set by one kind of adjustment plate 21, so that the manufacturing cost of the apparatus coupling structure 20 can be reduced as compared with the case where a plurality of kinds of parts are prepared.

Although the image forming system 1 according to the present embodiment includes the paper feeding apparatus 2A, the image forming apparatus 2B, the drying apparatus 2C, and the discharging apparatus 2D, the present disclosure is not limited thereto. At least one of the paper feeding apparatus 2A and the drying apparatus 2C may be incorporated in the image forming apparatus 2B, and the drying apparatus 2C and the discharging apparatus 2D may be incorporated in the image forming apparatus 2B (both not shown). That is, the plurality of coupled apparatuses 2 may include the image forming apparatus 2B, and for example, the image forming system 1 may include the image forming apparatus 2B incorporating at least one of the paper feeding apparatus 2A and the drying apparatus 2C, and the discharging apparatus 2D, or may include the paper feeding apparatus 2A, and the image forming apparatus 2B incorporating the drying apparatus 2C and the discharging apparatus 2D (both not shown).

In the description of the above embodiment, the image forming apparatus 2B is a printer for forming an image by an inkjet system, but this is not limited to this, and may be, for example, a printer for forming an image by an electrophotographic system (not shown). In the electrophotographic printer, the drying apparatus 2C is unnecessary. The image forming apparatus 2B is not limited to a printer, but may be, for example, a facsimile machine or a copier.

It should be noted that the description of the above-described embodiment shows one aspect of the apparatus connecting structure, image forming system and apparatus connecting method according to the present disclosure, and the technical range of the present disclosure is not limited to the above-described embodiment. The present disclosure may be varied, replaced, and modified without departing from the spirit of the technical thought, and the scope of the claims includes all embodiments that may be included within the scope of the technical thought.

1. An apparatus coupling structure comprising:
a plurality of coupled apparatuses which include a body frame constructed of a frame material formed with a fastening groove having a T-shaped cross section, and is installed on an installation surface, and
an adjustment plate which couples the adjacent coupled apparatuses, wherein
the adjustment plate is formed in a rectangular parallelepiped shape having a thickness capable of fitting into the fastening groove, long and short sides having a predetermined dimension,
the dimension of the long side of the adjustment plate corresponds to a bottom-up dimension from the installation surface to a bottom of the body frame,
the dimension of the short side of the adjustment plate corresponds to an inter-apparatus dimension of the adjacent body frames, and
the adjustment plate is fitted into the fastening grooves in a posture in which the short side is disposed between the adjacent coupled apparatuses, and the adjacent coupled apparatuses are coupled with the adjustment plate.

2. An image forming system comprising:
the apparatus coupling structure according to claim 1, wherein
the coupled apparatuses include an image forming apparatus for forming an image on a paper.

3. An apparatus coupling method for coupling a plurality of coupled apparatuses having a body frame constructed of a frame material having a fastening groove having T-shaped cross section using an adjustment plate formed in a rectangular parallelepiped shape having a thickness capable of being fitted to the fastening groove, long and short sides having a predetermined dimension, the apparatus coupling method comprising:
a height adjusting step in which a short side surface of the adjustment plate is brought into contact with an installation surface, the adjustment plate is stood upright on the installation surface, and a bottom-up dimension from the installation surface to the bottom of the body frame is adjusted to the dimension of the long side of the adjustment plate;
a horizontal adjusting step of fitting the adjustment plate to the fastening groove and leveling the body frame while referring to a level placed on the adjustment plate; and
a coupling adjusting step of holding the adjustment plate in a posture in which the short side is disposed between the adjacent coupled apparatuses, fitting the adjustment plate into the fastening grooves; and
coupling the adjacent coupled apparatuses with the adjustment plate.
